(19) United States
(12) Patent Application Publication
(10) Pub. No.: US 2011/0137791 A1
(43) Pub. Date: Jun. 9, 2011

(54) SYSTEM, METHOD AND APPARATUS FOR PROVIDING A UNIVERSAL FINANCIAL TRANSACTION GATEWAY FOR COMPUTING DEVICES

(75) Inventors: Bohdan Zabawskyj, Woodbridge (CA); Ian Hendry, Georgetown (CA); Al-Amyn Samji, Markham (CA)

(73) Assignee: REDKNEE INC, Mississauga, ON (CA)

(21) Appl. No.: 13/001,296

(22) PCT Filed: Jun. 30, 2008
(86) PCT No.: PCT/CA2008/001219

§ 371 Date: Dec. 23, 2010

(51) Int. Cl. G06Q 40/00

(52) U.S. Cl. 705/39; 705/35

(57) ABSTRACT

A universal financial transaction gateway for mobile computing devices is provided. The universal financial transaction gateway can comprise at least one core mobile network interface for connecting to a mobile electronic device via a core mobile network. The at least one interface is configured to emulate an interface inherent to the core mobile network. The gateway also comprises a transaction engine connected to the interface and configured to receive transaction instructions from the mobile electronic device via the core mobile network interface. The gateway also comprises a plurality of financial server interfaces for connecting to a plurality of accounts associated with a plurality of financial servers. The plurality of financial server interfaces is configured to emulate an interface inherent to each of the financial servers. The transaction engine is configured to effect the transaction instructions on the financial servers via the financial server interfaces.

### FIELD

The present specification relates generally to telecommunications and more particularly relates to a system, method and apparatus for providing a universal financial transaction gateway for mobile computing devices.

### BACKGROUND

Complexity and features of mobile computing devices, particularly devices such as personal digital assistants incorporating wireless telephony, email and web-browsing functions, and the like, continue to advance. There is little sign of such advances plateauing. There is much activity relative to providing enhanced applications and services to these electronic devices. One area of activity is the field of financial transactions, whereby mobile electronic devices are being used to conduct financial transactions. This area of activity can also impact conducting of financial transactions on other types of mobile computing devices. Current technology in this area, however, is a patchwork which frustrates universality.

### SUMMARY

An aspect of the specification provides a universal financial transaction gateway comprising at least one network interface for connecting to a mobile computing device via a network. At least one interface is configured to emulate an interface inherent to the network. The gateway further comprises a transaction engine connected to the interface that is configured to receive transaction instructions from the mobile computing device via the network interface. The gateway further comprises a plurality of financial server interfaces for connecting to a plurality of accounts associated with a plurality of financial servers. The plurality of financial server interfaces are configured to emulate an interface inherent to each of the financial servers. The transaction engine is also configured to effect the transaction instructions on the financial servers via the financial server interfaces.

The transaction engine can be also configured to effect transactions on accounts stored on the universal financial transaction gateway based on instructions received from the reports and analysis engine or as configured per data stored in the profile database.

The core mobile network interface can comprise at least one of an Unstructured Supplementary Service Data (USSD) gateway (not shown); a short message service (SMS) center (SMSC) (not shown); an interactive voice response (IVR) system (not shown); as well as Internet based protocols and interfaces including Wireless Application Protocol (WAP), Session Initiation Protocol, Hypertext Transfer Protocol, and Extensible Markup Language. The financial servers can comprise one or more of a credit card account, a credit line account, a bank account, a cash wire transfer account, a prepaid wireless account, an Operational Support System (OSS)/Business Support System (BSS) account, a securities trading platform, and a commodities trading platform.

The universal financial transaction gateway can further comprise a local account database configured to maintain at least one account associated with the mobile computing device or with a subscriber associated with the mobile computing device.

At least one of the financial servers can be configured to maintain at least one account associated with the mobile computing device or the subscriber. The universal financial transaction gateway can be configured to maintain at least one account associated with the mobile computing device or the subscriber.

At least one of the financial servers can be configured to maintain at least one account associated with another mobile computing device other than the mobile computing device, or with another subscriber associated with the another mobile computing device. The universal financial transaction gateway can be configured to maintain at least one account associated with another mobile computing device other than the mobile computing device, or with another subscriber associated with the another mobile computing device.

The universal financial transaction gateway can be configured to maintain at least one account associated with at least one financial server.

The transaction instructions can include at least one of a fund transfer between accounts; a loan request; an account balance request; a cash wire transfer; a credit or debit of a credit card account; a credit or debit of a bank account; a securities purchase or sale; a stock trade; a commodities purchase or sale, a futures purchase or sale and a bond purchase or sale.

The transaction instructions can include a first account on a first financial server associated with the mobile computing device or a first subscriber associated with the mobile computing device, and a second a account on a second financial server not associated with the mobile computing device or a second subscriber not associated with the mobile computing device.

The transaction instructions can include the transfer and/or exchange of monetary units as well as non-monetary units or credits. The transaction instructions can include the exchange of non-monetary units or credits into monetary units and conversely monetary units into non-monetary units or credits.

The transactions instructions can be associated with transfers/exchanges between devices, subscribers, and financial servers which are geographically distributed and can be in different countries. The transaction instructions can be associated with transfers/exchanges between devices, subscribers, and financial services which are supported by dissimilar networks (and associated interfaces) and can be operated by different entities.

Another aspect of the specification provides a transaction engine in accordance with the transaction engine of the gateway.

Another aspect of the specification provides a method of conducting a universal financial transaction comprising:

receiving transaction instructions via a network interface connected to mobile computing device via a network; the network interface configured to emulate an interface inherent to the network;

processing the transaction instructions;

sending the transaction instructions via at least one financial server interface; the financial server interface for connecting to a plurality of accounts associated with at least one financial server; the financial server interface configured to emulate an interface inherent to the financial server.

The method can further comprise validating the transfer request and only proceeding to the processing if the transfer request is successfully validated.

The processing can include effecting an account debit or credit at a local account database.

Another aspect of the specification comprises a computer readable medium configured to maintain a plurality of programming instructions in accordance with the foregoing and that are executable on a computing environment to provide a universal transaction gateway.

Another aspect of the specification provides a method of conducting a universal financial transaction comprising:

receiving transaction instructions via an interface connected to financial server;

processing the transaction instructions;

sending the transaction instructions via at least one financial server interface; the financial server interface for connecting to a plurality of accounts associated with at least one financial server; the financial server interface configured to emulate an interface inherent to the financial server.

Another aspect of the specification provides a method of conducting a universal financial transaction comprising:

receiving transaction instructions from a preconfigured profile or analysis and reporting engine;

processing the transaction instructions;

sending the transaction instructions via at least one financial server interface or; the financial server interface for connecting to a plurality of accounts associated with at least one financial server; the financial server interface configured to emulate an interface inherent to the financial server.

Another aspect of the specification provides a method of conducting a universal financial transaction comprising:

receiving transaction instructions via a network interface connected to mobile computing device via a network; the network interface configured to emulate an interface inherent to the network;

processing the transaction instructions;

sending the transaction instructions via at least one financial server interface; the financial server interface for connecting to a plurality of accounts associated with at least one financial server; the financial server interface configured to emulate an interface inherent to the financial server;

crediting or debiting an account maintained by the universal financial transaction gateway.

Another aspect of the specification provides a method of conducting a universal financial transaction comprising:

receiving transaction instructions via a network interface connected to mobile computing device via a network; the network interface configured to emulate an interface inherent to the network;

processing the transaction instructions;

crediting or debiting an account maintained by the universal financial transaction gateway.

Another aspect of the specification provides a method of conducting a universal financial transaction comprising:

receiving transaction instructions via an interface connected to financial server;

processing the transaction instructions;

crediting or debiting an account maintained by the universal financial transaction gateway.

Another aspect of the specification provides a method of conducting a universal financial transaction comprising:

receiving transaction instructions from a preconfigured profile or analysis and reporting engine;

processing the transaction instructions;

crediting or debiting an account maintained by the universal financial transaction gateway.

Another aspect of the specification is that a given financial transaction can be undertaken in any order subject to the validity of the request as determined by the universal financial gateway including configured limitations and controls stored in a profile database.

Another aspect of the specification is that a given transfer or exchange can involve currencies or non-monetary unit credits. Non-monetary unit credits can include credits associated with virtual goods such as ‘air-time’ as was tangible goods associated with commodities (e.g. bags of rice) and financial derivatives (e.g. units of stock, bonds).

Another aspect of the specification is that a given financial transaction can be subject to service charges and tariffs. The service charges or tariffs can be applied against the value associated with a given financial transaction. The applicable service charges and tariff charges can be distributed to and accumulated in at least one account associated with either a device, subscriber, or financial institution.

Another aspect of the specification is that a given financial transaction can associated with a loyalty or promotion program that results in a monetary or non-monetary award subject to the configuration of the loyalty or promotion program as stored in a profile database.

Another aspect of the specification is that the service charges or fees associated with a given financial transaction can be sponsored or subsidized in their entirety or in part either in connection with a loyalty or promotional program or in connection with a marketing program associated with at least one sponsor.

Another aspect of the specification is that non-zero debit and credit amounts maintained by the universal financial transaction gateway can be associated with interest charges based at least on the magnitude of the debit or credit amount, whether it is a debit or credit amount, the default currency associated with the account, the default location associated with the subscriber, the location of universal financial transaction gateway to the extent that a given account resides in a server located in a given geographic location.

### BRIEF DESCRIPTION OF THE DRAWINGS

Various embodiments will now be discussed, by way of example only, in relation to the attached Figures in which:

FIG. 1 is a schematic representation of a universal financial transaction system.

FIG. 2 is a schematic representation of the electronic device of FIG. 1.

FIG. 3 shows a flow-chart depicting a method of conducting a financial transaction using a mobile computing device.

FIG. 4 shows a flow-chart depicting another method of conducting a financial transaction using a mobile computing device.

FIG. 5 shows a flow-chart depicting another method of conducting a financial transaction using a mobile computing device.

FIG. 6 shows a flow-chart depicting another method of conducting a financial transaction using a mobile computing device.

### DETAILED DESCRIPTION OF THE EMBODIMENTS

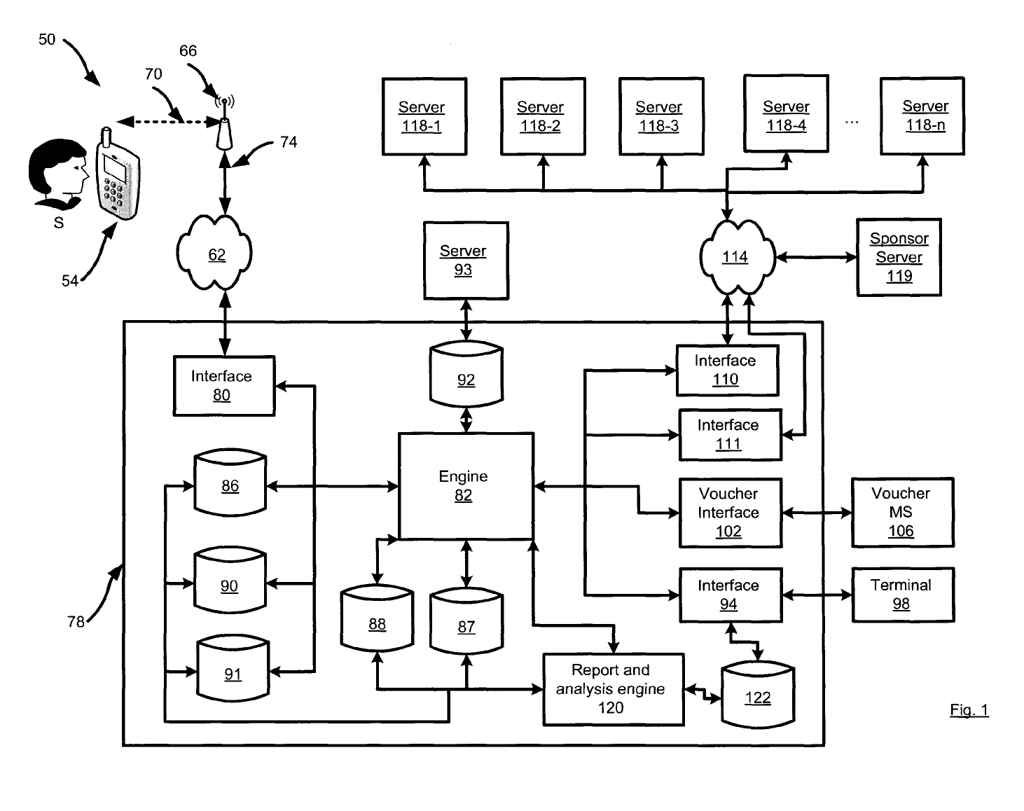

Referring now to FIG. 1, a universal financial transaction system is indicated generally at 50. System 50 comprises an electronic device 54 that is connectable to a core mobile network 62 via a base station 66. In a present embodiment electronic device 54 is mobile such that a wireless link 70 is employed between electronic device 54 and base station 66. Any known backhaul link 74 is used between base station 66 and core mobile network 62.

While the present embodiment contemplates a core mobile network 62 (for example, network technologies based on Global System for Mobile (GSM) communications, Code Division Multiple Access (CDMA), and the like), it is to be understood that in other embodiments other types of networks other than core mobile network technologies are contemplated, such as, for example, (e.g. the Internet or an Intranet connected to electronic device 54 via an Institute of Electrical and Electronic Engineers (IEEE) 802.11 or 802.16 connection).

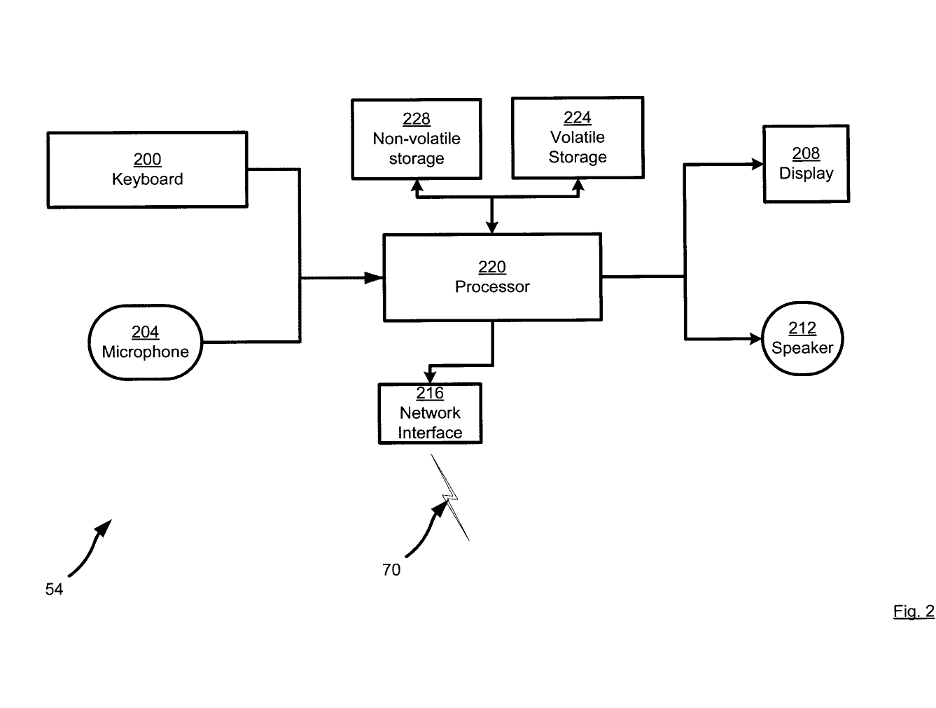

Referring briefly to FIG. 2, electronic device 54 is shown in greater detail. Electronic device 54 in a present embodiment is based on the computing environment of a mobile wireless device that comprises the functionality of a cellular telephone, wireless email pager, web-browser and a personal digital assistant. Electronic device 54 thus includes a hardware configuration that comprises one or more input devices in the form of a keyboard 200, microphone 204 and the like; one or more output devices in the form of a display 208, a speaker 212 and the like; and a network interface 216, implemented in the form of a radio in the present embodiment. Network interface 216 is configured for conducting wireless communications over link 70. The foregoing components are interconnected by a microcomputer comprised of one or more central processing units 220 connected to volatile memory 224 (e.g. random access memory) and non-volatile memory 228 (e.g. FLASH memory). It should now be understood that in other embodiments electronic device 54 can be based on other types of mobile computing devices, including the computing environment of a desktop computer, a workstation, a thin-client or the like.

Referring again to FIG. 1, system 50 also comprises a universal transaction gateway 78 that connects to core mobile network 62. Universal transaction gateway 78 can be based on any suitable server computing environment. While not shown herein, it will understood by those skilled in the art the server includes a hardware configuration that may comprise one or more input devices in the form of a keyboard, a mouse and the like; one more output devices in the form of a display, and the like; a network interface for conducting network communications; all of which are interconnected by a microcomputer comprised of one or more central processing units that itself is connected to volatile memory and non-volatile memory. (The computing environment shown in FIG. 2 presents an analogous environment to the computing environment of gateway 78). As will become apparent from the following discussions, the computing environment of universal transaction gateway 78 will also comprise software processes that can be read from and maintained in non-volatile memory (or other computer readable media) that can be executed on the one or more central processing units. It will also be understood that universal transaction gateway 78 can be implemented as a plurality of servers to provide scalability.

Universal transaction gateway 78 also maintains at least one client interface 80 that is configured to provide an interface with electronic device 54 corresponding to the interfaces offered by electronic device 54. For example, at least one client interface 80 can be one or more of the following: an interface with an Unstructured Supplementary Service Data (USSD) gateway (not shown); a short message service (SMS) center (SMSC) (not shown); an interactive voice response (IVR) system (not shown). The client interface 80 can also interface with electronic device 54 with a number of Internet protocols (e.g. Wireless Application Protocol (WAP), Session Initiation Protocol, Hypertext Transfer Protocol, and Extensible Markup Language). In the latter case, those skilled in the art will recognize that an application such as an Internet or WAP browser or an application specifically designed to interface via universal transaction gateway can be resident on electronic device 54. The client interface 80 can support one or more of the foregoing interfaces and protocols concurrently. In a given embodiment the client interface 80 will be used to facilitate the ability of a given subscriber to initiate, modify, or terminate requests, select among a number of options, as well as receive notifications. In a given embodiment, the messages or protocols supported via client interface 80 can be encrypted using encryption algorithms. Those skilled in the art will recognize that a variety of public-key or private-key encryption algorithms can be used to encrypt the messages or protocols supported via client interface 80.

Other types of interfaces that can be included in at least one client interface 80 will now occur to those skilled in the art.

Universal transaction gateway 78 also comprises a transaction engine 82 that is configured to effect transfers between various accounts or databases according to instructions received from electronic device 54, subscriber S, or from servers 118-1 to 118-n. The transaction engine can also effect transfers between various accounts or databases according to instructions received from the profile database 86 or report and analysis engine 120. Transaction engine 82 thus connects to a profile database 86 which maintains account information that corresponds to electronic device 54 or subscriber S, including data representing at least a unique identifier for each account. More than one account may be associated with electronic device 54 or subscriber S. Other account information can also be maintained by profile database 86, as needed or desired, including a default currency denomination associated with each account and any rules to be applied to the transfers conducted by universal transaction gateway 78, such as the class or category of accounts (e.g. retail subscriber, reseller, distributer), passwords, identity information such as personal identification numbers (PINs), login information, exclusion lists (blacklists) of source or destination accounts, inclusion lists (whitelists) of source or destination accounts, limits or restrictions such as maximum transfer limits over a given chronological period (e.g. 100 units of a given currency over one day), rules relating to account hierarchies and transfer restrictions between classes or categories of accounts, account information including account identifiers and account addressing and/or routing information, promotion identifiers, promotion or loyalty promotion status and state, limits or restrictions relating to security or anti-fraud features, time limitations or expiry dates. The profile database can also contain other data and rules that are not associated with a given account but can be applied to transfers conducted by universal transaction gateway 78 such as rules relating to government regulatory compliance, privacy restriction management, currency exchange data, non-monetary unit or credit exchange data, service charges or other tariff data, data relating to promotional and loyalty programs, interest rates for accounts which have a debit, interest rates for accounts that have a credit.

Universal transaction gateway 78 also comprises a local account database 90, whereby an account respective to device 54 (or subscriber S) is maintained locally within gateway 78 that can be used as part of any transfers that are effected by gateway 78. More than one local account 90 can be associated with a given device 54 (or subscriber S).

Universal transaction gateway 78 also comprises a customer care interface 94, whereby a customer care terminal 98 can interact universal transaction gateway 78 in order to provision the access of device 54 to universal transaction gateway 78. Customer care terminal 98 can be operated by a carrier or network operator associated with electronic device 54 or subscriber S, or it can be a self-provisioning terminal 98 so that the user of electronic device 54 can provision the access of device 54 to universal gateway 78. The customer care interface 84 can also be used to initiate the generation of reports produced by the report and analysis engine 120 or retrieve reports stored in the report and analysis database 122.

Universal transaction gateway 78 also comprises a local commission database 91, whereby commission accounts respective to device (or subscriber S), financial server 118, or the operator of universal transaction gateway 78 (not shown) is maintained locally within gateway 78 that can be used as part of any transfers that are effected by gateway 78. More than one commission account can be associated with a given device 54 (or subscriber S), financial sever 118, or the operator of gateway 78. Transaction engine 82 thus connects to local commission database 91 for the purpose of effecting transfers to and from a given commission account associated with a given device 54 (subscriber S), financial server 118, or operator of gateway 78.

Universal transaction gateway 78 also comprises a local credit account database 92, whereby at least one general credit account is maintained locally within gateway 78 that can be used as part of loans (or related transactions) that are requested by a give device 54 (or subscriber S). Thus, for example, where a request for a loan is received from device 54 (or subscriber S), then the loan funds can be obtained from local credit account database 92, and loan repayments made to loan credit account database 92 with appropriate interest payments. Loan credit account database 92 can be connected to a loan capital server 93, so that currency (or other units, be they monetary or non-monetary credits) can be transferred between loan credit account database 92 and server 93. Server 93 then, itself, can be connected to capital markets (e.g. stock exchanges or the like) to capitalize the amounts maintained on local credit account database 92. In this manner, shares or other equity units can be bought, sold and traded via server 93, in universal transaction gateway 78 which are maintained in local credit account database 92. Alternatively, shares or other equity units in universal transaction gateway 78 can be bought, sold and traded by other subscribers S that connected to gateway 78, which are maintained in local credit account database 92. Universal transaction gateway 78 also comprises a voucher recharge interface 102, whereby vouchers, such as prepaid vouchers that can be used for prepaid access by device 54 on core mobile network 62, can be redeemed via universal transaction gateway 78 according to the features of universal transaction gateway 78. Voucher recharge interface 102 is configured to interact with preexisting carrier voucher management system(s) 106 so that no modification is needed to such existing voucher management system(s) 106. Thus, for example, where in a preexisting voucher management system 106, codes (e.g. via IVR, USSD, SMS, Web-browser) can be entered into preexisting voucher management system 106 that correspond to a particular prepaid voucher, so that voucher management system 106 can “top-up” a particular pre-paid account, then voucher interface 102 will interact voucher management system 106 to receive top-up commands as if that voucher management system 106 were a known service control point (SCP) or the like. The engine 82 can transfer funds received via interface 102 to an account stored on one or more financial servers as well as a local account stored in local database 90.

Universal transaction gateway 78 also comprises at least one financial server interface 110 that can communicate over one or more different wide area networks 114, such as the Internet, with a plurality of different financial servers 118-1, 118-2, 118-3 . . . 118-n (Collectively, financial servers 118, and generically financial server 118). Each financial server 118 can be based on any existing or future-conceived type of financial server that can maintain a financial account associated with a particular type of financial account. For example, server 118-1 can be a server that belongs to VISA and maintains one or more VISA credit card accounts that are provisioned to be associated with electronic device 54 or subscriber S, and whereby an identifier for each account is maintained in database 86 as being associated with electronic device 54 or subscriber S. In this example, financial server interface 110 is configured to interact with the VISA financial server 118-1 according to the predefined protocols and interfaces that are already used to interact with VISA financial server 118-1, such as by way of non-limiting example, a point-of-sale terminal maintained by a commercial establishment that is configured to both debit and credit the account(s) maintained VISA financial server 118-1. Example protocols and interfaces include International Organization for Standardization (ISO) 8583 Standard for Financial Transaction Card Originated Messages—Interchange message specifications and ISO 20022 Financial Services as well as their derivatives. Example protocols and interfaces also include interfaces based on electronic data interchange (EDI) including Electronic Data Interchange For Administration, Commerce, and Transport (EDIFACT) as well as their derivatives. Other exemplary known protocols and interfaces include web-pages or email money transfer interfaces as well as Application Programming Interfaces (API) based on CORBA (Common Object Request Broker Architecture) or SOAP/XML (Simple Object Access Protocol/Extensible Markup Language).

As another example, server 118-2 can be a server that belongs to a bank and maintains one or more personal bank accounts (e.g. a checking or savings account) that are provisioned to be associated with electronic device 54 or subscriber S, and whereby an identifier for each account is maintained in database 86 as being associated with electronic device 54 or subscriber S. In this example, financial server interface 110 is configured to interact with the bank account financial server 118-2 according to the predefined protocols and interfaces that are already used to interact with bank account financial server 118-2, such as, by way of non-limiting example, a point-of-sale terminal maintained by a commercial establishment that is configured to both debit and credit the bank account(s) maintained bank account server 118-2. Example protocols and interfaces include ISO 8583 Standard for Financial Transaction Card Originated Messages—Interchange message specifications and ISO 20022 Financial Services as well as their derivatives. Example protocols and interfaces also include interfaces based on EDI including EDIFACT as well as their derivatives. Other exemplary known protocols and interfaces include web-pages or email money transfer interfaces as well as Application Programming Interfaces based on CORBA or SOAP/XML.

As another example, server 118-3 can be a server that belongs to a wire transfer company (such as Western Union) and maintains a wire-transfer accounts that are provisioned to be associated with electronic device 54 or subscriber S, and whereby an identifier for each account is maintained in database 86 as being associated with electronic device 54 or subscriber S. In this example, financial server interface 110 is configured to interact with the wire transfer financial server 118-2 according to the predefined protocols and interfaces that are already used to interact with wire transfer financial server 118-2, such as, by way of non-limiting example, a terminal maintained by a Western Union franchisee that is configured to both debit and credit the account(s) maintained by wire transfer account server 118-2 in association with the wiring of funds for immediate conversion into cash. Example protocols and interfaces include ISO 8583 Standard for Financial Transaction Card Originated Messages—Interchange message specifications and ISO 20022 Financial Services as well as their derivatives. Example protocols and interfaces also include interfaces based on EDI including EDIFACT as well as their derivatives. Other exemplary known protocols and interfaces include web-pages or email money transfer interfaces as well as Application Programming Interfaces based on CORBA or SOAP/XML.

As another example, server 118-4 can be an SCP that belongs to a carrier that maintains a prepaid wireless account that is provisioned to be associated with electronic device 54 (or subscriber S), and whereby an identifier for that account is maintained in database 86 as being associated with electronic device 54 (or subscriber S). In this example, financial server interface 110 is configured to interact with SCP financial server 118-4 according to the predefined protocols and interfaces that are already used to interact with an SCP, that is configured to both debit and credit the account(s) maintained by SCP server 118-4 in association pre-paid funds that provide airtime or other wireless services to electronic device 54 or subscriber S. Example protocols include Application Programming Interfaces based on CORBA or SOAP/XML. The foregoing teachings relative to accessing account structures that are maintained by a network operator can be supplemented by the teachings of Applicant's copending application disclosed in US 2004/0105424 “Method for implementing an Open Charging (OC) middleware platform and gateway system” the contents of which are incorporated herein by reference. Those skilled in the art will recognize that the carrier that operates server 118-4 can also operate core mobile network 62. In alternative embodiments, a given SCP server 118-4 can be operated other mobile networks (not shown) that are associated other devices (not shown) or subscribers (not shown) that are associated with a given destination account that is distinct from device 54 or subscriber S.

As another example, server 118-n can be an data repository associated with a carrier's Operational Support System (OSS)/Business Support System (BSS) infrastructure maintains an account that is provisioned to be associated with electronic device 54 or subscriber S, and whereby an identifier for that account is maintained in database 86 as being associated with electronic device 54 or subscriber S. In this example, financial server interface 110 is configured to interact with data repository financial server 118-n according to the predefined protocols and interfaces that are already used to interact with an data repository associated with a carrier's OSS/BSS) infrastructure. Example protocols include Application Programming Interfaces based on CORBA or SOAP/XML. The foregoing teachings relative to accessing account structures that are maintained by a network operator can be supplemented by the teachings of Applicant's copending application disclosed in US 2004/0105424 “Method for implementing an Open Charging (OC) middleware platform and gateway system” the contents of which are incorporated herein by reference. Those skilled in the art will recognize that the carrier that operates server 118-n can also operate core mobile network 62. In alternative embodiments, a given server 118-n can be operated other mobile networks (not shown) that are associated other devices (not shown) or subscribers (not shown) that are associated with a given destination account that is distinct from device 54 or subscriber S.

It will now be understood that a plurality of other now known or future contemplated financial servers 118 are contemplated, and that where such financial servers 118 are provided that interface 110 is configured to the interfaces that have been predefined for those financial servers 118. Also a plurality of the same types of servers can be provisioned as well, so that a plurality of financial institutions and network operators can interface with the universal transaction gateway 78 concurrently.

In a given embodiment, the messages or protocols supported via interface 110 can be encrypted using encryption algorithms. Those skilled in the art will recognize that a variety of public-key or private-key encryption algorithms can be used to encrypt the messages or protocols supported via client interface 110.

Universal transaction gateway 78 also comprises an event record database 87 that will store event records and logs that describe the details of transactions processed via the universal transaction gateway as well as configuration or provisioning changes made to elements of the universal transaction gateway 78 (for example, a modification to a given account stored in the local account database 90). The event records and logs can be retrieved for subsequent usage and/or inspection.

Universal transaction gateway 78 also comprises a reporting and analysis engine 120 that processes the event records and logs stored in event record database 87 for the purpose of generating reports that pertain to the operation of universal transaction gateway 78. Examples of reports include settlement reports that contain a summary of transactions and the associated aggregate values of funds transferred between network operators and between operators and financial institutions over a given chronological period as well as settlement reports pertaining to any commissions associated with the distribution of applicable service charges or tariffs. Those skilled in the art will recognize that a variety of other settlement reports can be generated to facilitate audit, reconciliation, or dispute resolution processes. Other examples or reports that can be generated include demographic reports that provide utilization data as a function of various parametric attributes (e.g. value of transaction, source account, destination account) for a given subset of device, subscriber, or server (financial institution). The reporting and analysis engine 120 can either prepare reports upon demand or on a periodic basis. Reports can be stored on the reports database 122 for subsequent retrieval. In one embodiment, the reporting and analysis engine 120 can highlight potentially fraudulent activity and update the profile database 86 to impose additional controls or limits as well as notify the operator and/or subscriber of suspected fraudulent activity and generate a corresponding report on the reports database 122 for subsequent retrieval.

Universal transaction gateway 78 also comprises at least one sponsor server interface 111 that can communicate over one or more different wide area networks 114, such as the Internet, with a plurality of different sponsor servers 119 (Collectively, sponsor servers 119, and generically sponsor server 119). Each sponsor server 119 can be based on any existing or future-conceived type of sponsor server that can configure or maintain a sponsorship or marketing program in connection with a given financial transaction supported via universal transaction gateway 78. Example protocols and interfaces include web-pages as well as Application Programming Interfaces (API) based on CORBA (Common Object Request Broker Architecture) or SOAP/XML (Simple Object Access Protocol/Extensible Markup Language).

Universal transaction gateway 78 also comprises a sponsorship database 88 that maintains data that corresponds to sponsor server 119, including data representing a unique identifier for each sponsor and marketing program. More than one marketing program can be associated with sponsor server 119. Other sponsorship and marketing information can also be maintained by sponsor server 119, as need or desired, including the parametric attributes and rules associated with a given marketing program (e.g. the percentage of applicable service charges and fees that will be sponsored), inclusion lists and ranges, exclusion lists and ranges, the nature of the marketing message to be conveyed and applicable messaging media to be used (e.g. SMS, USSD, Multimedia Message Service, e-mail).

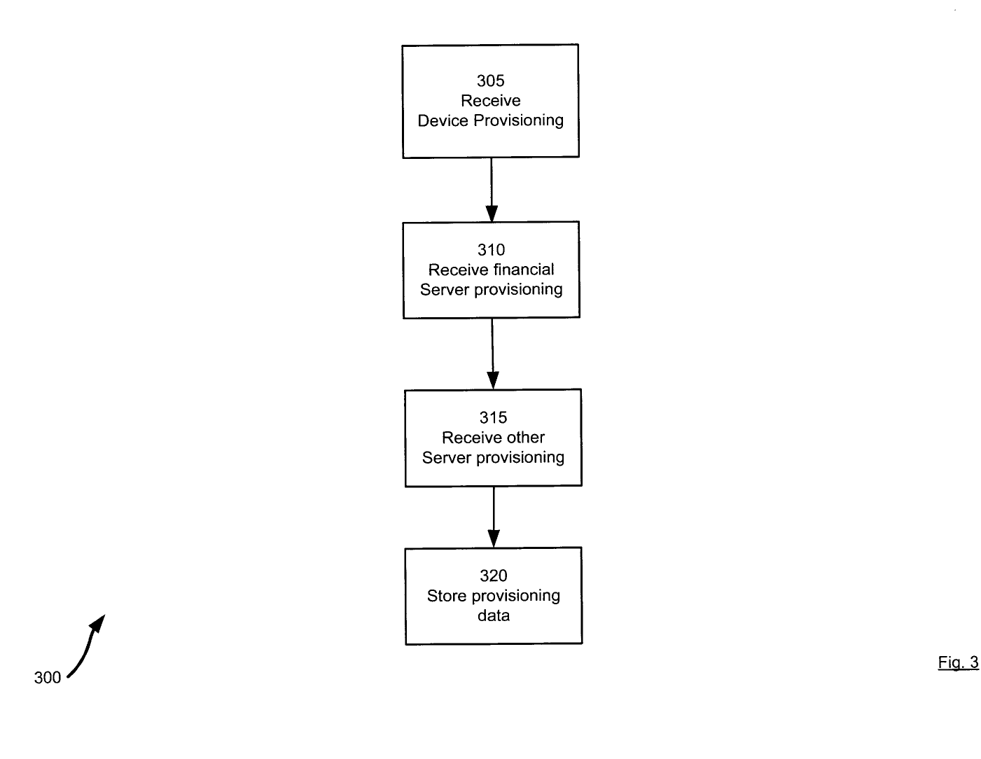

Referring now to FIG. 3, a method of provisioning a universal transaction gateway is provided in the form of a flowchart and indicated generally at 300. Method 300 can be implemented on system 50 in order to effect a financial transaction, but it should be understood that variations to at least one of method 300 and system 50 are contemplated.

At block 305, device provisioning is received. Block 305 is performed in association with device 54 or subscriber S, to provide at least a unique identifier (e.g. International Mobile Equipment Identity (IMEI), International Mobile Subscriber Identity (IMSI), Mobile Systems International Subscriber Identity Number (MSISDN), Uniform Resource Identifier (URI) (e.g. John.Doe@network_operator.com)) for device 54 or Subscriber S so that the unique identifier can be used in association with financial transactions conducted by gateway 78.

At block 310, financial server provisioning is received (for example, service or tariff elements which are specific financial server(s) 118). Block 310 is performed in association with the unique identifier from block 310 as well as in relation to one or more accounts maintained by financial server(s) 118, so that a particular account maintained by financial server(s) 118 is associated with device 54 or subscriber S.

At block 315, other provisioning data associated with the universal transaction gateway 78 is received (for example, currency exchange data, data relating to promotional and loyalty programs, data relating to sponsorship and marketing programs, interest rates for accounts which have a debit, interest rates for accounts that have a credit).

At block 320, the provisioning data is stored. Block 320 comprises compiling the data received at block 305, 310, and 315 and storing that data on profile database 86, sponsorship database 88, local database 90, or commission database 91.

The provisioning data at block 315 can additionally include any unique expected instructions from device 54 or subscriber S as well as financial servers 118 in relation to transactions to be performed on the accounts maintained by provisioned financial servers 118 or the universal transaction gateway 78.

It should be understood that all or part of method 300 can be re-performed in order to provide updates or modifications to the data on profile database 86, sponsorship database 88, local database 90, or commission database 91. It should also be understood that data relevant to the operation of the universal financial transaction gateway 78 as maintained by profile database 86, sponsorship database 88, local database 90, or commission database 91 can be generated and stored using other methodologies other than method 300. Of note is that not all blocks of method 300 need be performed in order to generate data relevant to the operation of the universal financial transaction gateway 78 as maintained by profile database 86, sponsorship database 88, local database 90, or commission database 91

Table I shows a purely exemplary, and simplified, set of contents that can be generated as a result of performing method 300.

TABLE I
Exemplary Contents of Profile database 86

| Field Number | Field Name | Field Contents |
|---|---|---|
| 1 | Identifier of | +1-234-567-8901 |
| | Device (or | |
| | Subscriber) | |
| 2 | Financial | VISA Account Number |
| | Server 118-1 | 5555-5555-5555-5555; |
| | Identifier | Currency: United States |
| | | Dollars |
| 3 | Financial | 1 |
| | Server 118-1 | |
| | Account Menu | |
| | Identifier | |
| 4 | Financial | XYZ Bank Co. Account |
| | Server 118-2 | Number |
| | Identifier | 4444-4444-4444-4444; |
| | | Currency: United States |
| | | Dollars |
| 5 | Financial | 2 |
| | Server 118-2 | |
| | Account Menu | |
| | Identifier | |
| 6 | USSD | *9999# |
| | Transfer | |
| | Request | |
| | String | |
| 7 | Financial | AirMAX Operator |
| | Server 118-4 | +1-234-567-8901; |
| | Identifier | Currency: United States |
| | | Dollars |
| 8 | Financial | 3 |
| | Server 118-4 | |
| | Account Menu | |
| | Identifier | |
| 9 | Exclusion List | MSISDN: +1-234-789-0123 |
| 10 | Transfer | Total: $100 per day |
| | Limits | Per destination account: $10 |
| | | per day |
| 11 | Promotion IDs | Air_time_promotion_a |
| 12 | Default | United States Dollars |
| | Currency | |
| 13 | Class | Retail Subscriber |

Field 1 of Table I, “Identifier of Device or Subscriber” contains a unique identifier for device 54 (or another applicable device) or subscriber S, and in the present example includes the MSISDN+1-234-567-8901.

Field 2 of Table I, “Financial Server 118-1 Identifier” contains a unique identifier for the account on Financial Server 118-1 that is to be associated with device 54 or subscriber S. Field 2 also contains, the currency associated with account on Financial Server 118-1.

Field 3 of Table I, “Financial Server 118-1 Menu Identifier” contains a code or sequence that will be used to identify the financial server in Field 2 in a menu.

Field 4 of Table I, “Financial Server 118-2 Identifier” contains a unique identifier for the account on Financial Server 118-2 that is to be associated with device 54 or subscriber S. Field 4 also contains, the currency associated with account on Financial Server 118-2.

Field 5 of Table I, “Financial Server 118-2 Menu Identifier” contains a code or sequence that will be used to identify the financial server in Field 4 in a menu.

Field 6 of Table I, “USSD Transfer Request String” contains a USSD code that is recognized by core mobile network 62 as indicating that a transfer via gateway 78 is being invoked by device 54.

Field 7 of Table I, “Financial Server 118-4 Identifier” contains a unique identifier for the account on Financial Server 118-4 that is to be associated with device 54 or subscriber S. Field 7 also contains, the currency associated with account on Financial Server 118-4.

Field 8 of Table I, “Financial Server 118-4 Menu Identifier” contains a code or sequence that will be used to identify the financial server in Field 7 in a menu.

Field 9 of Table I, “Exclusion List” contains an identifier associated with an account that is recognized by the universal transfer gateway as an account to which a transfer request from device 54 or subscriber S (as identified per Field 1) will be refused.

Field 10 of Table I, “Transfer Limits” contains parametric information with regards to transfer limits over a given chronological period associated with device 54 or subscriber S (as identified per Field 1).

Field 11 of Table I, “Promotion IDs” contains parametric information pertaining to promotions or loyalty programs that may be invoked depending on the nature of a given transfer request associated with device 54 or subscriber S (as identified per Field 1).

Field 12 of Table I, “Default Currency” contains parametric information pertaining to the default currency associated with a given transfer request associated with device 54 or subscriber S (as identified per Field 1).

Field 13 of Table 1, “Class”, contains the class of subscriber, and in the present example describes the subscriber to be a ‘retail subscriber’.

Table 2 shows another complementary, purely exemplary, and simplified, set of contents that can be generated as a result of performing method 300.

TABLE 2
Exemplary Contents of Profile database 86

| Field Number | Field Name | Field Contents |
|---|---|---|
| 1 | US to Euro | 0.64102 |
| | Rate | |
| 2 | Euro to US | 1.45301 |
| | Rate | |
| 3 | Non-Monetary | 10.2 |
| | Unit A credit to | |
| | US dollar | |
| 4 | US dollar to | 0.098039 |
| | Non-Monetary | |
| | Unit A credit | |
| 5 | Service | Retail Subscriber to Retail |
| | Charge - | Subscriber; |
| | Retail to retail | 1% applied against funds |
| | | transferred |
| 6 | Service | Retail Subscriber to Financial |
| | Charge - | Server 118-1 |
| | retail to | $2.00 default currency of |
| | financial | financial server 118-1 applied |
| | server (visa) | against donor account |
| 7 | Credit Interest | Credit; |
| | Rate | 0.75% per year effective, to |
| | | be applied monthly to non- |
| | | zero accounts in local |
| | | databases |
| 8 | Debit Interest | Debit; |
| | Rate | 2.5% per year effective, to be |
| | | applied daily to non-zero |
| | | accounts in local databases |
| 9 | Promotions | Air₋ time₋ promotion₋ a; |
| | | $2 of default currency to be |
| | | credited to local account for |
| | | every 10 transactions. |
| 10 | Regulatory | $200 per day |
| | Compliance - | |
| | South Africa | |

Field 1 of Table 2, “US to Euro Rate” contains the US dollar to Euro exchange rate, and in the present example includes a conversion rate of 1 US dollar to 0.64102 Euros.

Field 2 of Table 2, “Euro to US Rate” contains the Euro to US exchange rate, and in the present example includes a conversion rate of 1 Euro to 1.45301 dollars.

Field 3 of Table 2, “Non-Monetary Unit A credit to US Dollar” contains the non-monetary unit A credit to US dollar exchange rate, and in the present example includes a conversion rate of 10.2 non-monetary unit A credits to 1 US dollar.

Field 4 of Table 2, “US Dollar to Non-Monetary Unit A credit” contains the US dollar to non-monetary unit A credit exchange rate, and in the present example includes a conversion rate of 1 US dollar to 0.098039 non-monetary unit A credits.

Field 5 of Table 2, “Service Charge—Retail to retail” contains the retail subscriber to retail subscriber transfer service charge, and in the present example is equal to 1% to be applied against the funds to be transferred prior to deposit in the destination account.

Field 6 of Table 2, “Service Charge—Retail to financial sever (visa)”, contains the retail subscriber to financial server 118-1 transfer service charge, and in the present example is equal to $2.00 of the default currency associated with financial server 118-1 to be applied against the donor account.

Field 7 of Table 2, “Credit Interest Rate”, contains the interest rate to be applied to non-zero credit accounts stored in the local database, and in the present example is equal to an effective annual interest rate of 0.75% to be applied monthly.

Field 8 of Table 2, “Debit Interest Rate”, contains the interest rate to be applied to non-zero debit accounts stored in the local database, and in the present example is equal to an effective annual interest rate of 2.5% to be applied daily

Field 9 of Table 2, “Promotions”, describes the configuration of a given promotion (or promotions), Air_time_promotion_A, and in the present example is equal to $2 of subscriber's default currency to be credited to the subscriber's local account for every 10 financial transactions executed by the universal transaction gateway 78.

Field 10 of Table 2, “Regulatory Compliance—South Africa”, describes the configuration of the regulatory compliance rules to be applied for transactions involving a given jurisdiction, and in the present example is described as a transactional limit of $200 per day.

It will be apparent that several configured parametric attributes that govern the operation of a given transfer as executed by the universal transaction gateway 78 may be specified in a more granular fashion. For example, currency exchange rates can be specified for each financial server 118 or interest rates can be specific per currency or geography (country).

Table 3a shows another complementary, purely exemplary, and simplified, set of contents that can be generated as a result of performing method 300.

TABLE 3a
Exemplary Contents of local database 90

| Field Number | Field Name | Field Contents |
|---|---|---|
| 1 | Identifier | +1-234-567-8901; account |
| | | 00aa2 |
| 2 | Account | $5.50 |
| 3 | Currency | US Dollars |

Field 1 of Table 3a, “Identifier” contains the identifier associated with a device 54 or subscriber S or financial server 118, and in the present example includes an MSISDN identifier+1-234-567-8901 and an account identifier 00aa2 associated with a subscriber.

Field 2 of Table 3a, “Account” contains the debit or credit amount in a given currency for a given device 54 or subscriber S or financial server 118, and in the present example includes a value of $5.50.

Field 3 of Table 3a, “Currency” contains the associated non-monetary unit or currency for a given account, and in the present example includes a ‘US Dollars’.

Table 3a shows another complementary, purely exemplary, and simplified, set of contents that can be generated as a result of performing method 300.

TABLE 3b
Exemplary Contents of local database 90

| Field Number | Field Name | Field Contents |
|---|---|---|
| 1 | Identifier | +1-234-567-8901; account |
| | | 00bb2 |
| 2 | Account | −$21.01 |
| 3 | Currency | US Dollars |

Field 1 of Table 3b, “Identifier” contains the identifier associated with a device 54 or subscriber S or financial server 118, and in the present example includes an MSISDN identifier+1-234-567-8901 and an account identifier 00bb2 associated with a subscriber.

Field 2 of Table 3b, “Account” contains the debit or credit amount in a given currency for a given device 54 or subscriber S or financial server 118, and in the present example includes a value of −$21.01

Field 3 of Table 3b, “Currency” contains the associated non-monetary unit or currency for a given account, and in the present example includes a ‘US Dollars’.

Table 4 shows another complementary, purely exemplary, and simplified, set of contents that can be generated as a result of performing method 300.

TABLE 4
Exemplary Contents of commission database 91

| Field Number | Field Name | Field Contents |
|---|---|---|
| 1 | Identifier | Financial Server 118-1; 000A- |
| | | 353K3S-9523D |
| 2 | Account | $45323.13 |
| 3 | Currency | US Dollars |

Field 1 of Table 4, “Identifier” contains the identifier associated with a device 54 or subscriber S or financial server 118, and in the present example includes an alphanumeric identifier 000A-353K3S-9523D associated with financial server 118-1.

Field 2 of Table 4, “Account” contains the debit or credit amount in a given currency for a given device 54 or subscriber S or financial server 118, and in the present example includes a value of $45323.13.

Field 3 of Table 4, “Currency” contains the associated non-monetary unit or currency for a given account, and in the present example includes a ‘US Dollars’.

Table 5 shows another complementary, purely exemplary, and simplified, set of contents that can be generated as a result of performing method 300.

TABLE 5
Exemplary Contents of Profile database 86

| Field Number | Field Name | Field Contents |
|---|---|---|
| 1 | Identifier of | +1-890-234-5678 |
| | Device or | |
| | Subscriber | |
| 2 | Financial | ABC Bank Co. Account |
| | Server 118-5 | Number |
| | Identifier (not | 8888-8888-8888-8888; |
| | shown) | Currency: United States |
| | | Dollars |
| 3 | Financial | 1 |
| | Server 118-5 | |
| | Account Menu | |
| | Identifier | |
| 4 | USSD | *9999# |
| | Transfer | |
| | Request | |
| | String | |
| 5 | Financial | AirMAX Operator |
| | Server 118-4 | +1-890-234-5678; |
| | Identifier | Currency: United States |
| | | Dollars |
| 6 | Financial | 2 |
| | Server 118-4 | |
| | Account Menu | |
| | Identifier | |
| 7 | Transfer | Total: $1000 per day; |
| | Limits | Per destination account: $20 |
| | | per day to retail subscribers; |
| | | Not permitted to transfer |
| | | funds to other reseller |
| | | accounts. |
| 8 | Promotions | Reseller_promotion_a; |
| | | $10 per $1000 value |
| | | transferred |
| 9 | Default | US Dollars |
| | Currency | |
| 10 | Class | Reseller |

Field 1 of Table 5, “Identifier of Device or Subscriber” contains a unique identifier for device 54 (or another applicable device) or subscriber S, and in the present example includes the MSISDN+1-890-234-5678.

Field 2 of Table 5, “Financial Server 118-5 Identifier” contains a unique identifier for the account on Financial Server 118-5 that is to be associated with device 54 or subscriber S. Field 2 also contains, the currency associated with account on Financial Server 118-5.

Field 3 of Table 5, “Financial Server 118-5 Menu Identifier” contains a code or sequence that will be used to identify the financial server in Field 2 in a menu.

Field 4 of Table 5, “USSD Transfer Request String” contains a USSD code that is recognized by core mobile network 62 as indicating that a transfer via gateway 78 is being invoked by device 54.

Field 5 of Table 5, “Financial Server 118-4 Identifier” contains a unique identifier for the account on Financial Server 118-4 that is to be associated with device 54 or subscriber S. Field 5 also contains, the currency associated with account on Financial Server 118-4.

Field 6 of Table 5, “Financial Server 118-4 Menu Identifier” contains a code or sequence that will be used to identify the financial server in Field 5 in a menu.

Field 7 of Table 5, “Transfer Limits” contains parametric information with regards to transfer limits over a given chronological period associated with device 54 or subscriber S (as identified per Field 1). In the present example, the field indicates that the device or subscriber is limited to $1000 per day; $20 to a given retail subscriber account.

Field 8 of Table 5, “Promotions” contains parametric information pertaining to promotions or loyalty programs that may be invoked depending on the nature of a given transfer request associated with device 54 or subscriber S (as identified per Field 1). In the present example, the field indicates that the device or subscriber is associated with Reseller_promotion_a′ with the parametric attributes of a promotional value of $10 per $1000 of value transferred.

Field 9 of Table 5, “Default Currency” contains parametric information pertaining to the default currency associated with a given transfer request associated with device 54 or subscriber S (as identified per Field 1).

Field 10 of Table 5, “Class”, contains the class of subscriber, and in the present example describes the subscriber to be a ‘reseller subscriber’.

Table 6 shows another complementary, purely exemplary, and simplified, set of contents that can be generated as a result of performing method 300.

TABLE 6
Exemplary Contents of sponsorship database 88

| Field Number | Field Name | Field Contents |
|---|---|---|
| 1 | Identifier | Sponsor Server 119; |
| | | FG001A-98DDJ; Patriotic |
| | | Industries; |
| 2 | Program | Presidents_day_promotion_A |
| | Name | |
| 3 | Inclusion List | Financial Server 118-2; XYZ |
| | | Bank Co.; |
| 4 | Program | 100% of service charges and |
| | | fees to and from accounts in |
| | | the inclusion list; 00:00 Feb. |
| | | 16, 2009 to 23:59 Feb. 16, |
| | | 2009 |
| 5 | Marketing | “Your financial transaction |
| | Message | was free, courtesy of Patriotic |
| | | Industries”; via SMS to |
| | | associated devices or |
| | | subscribers |

Field 1 of Table 6, “Identifier” contains the identifier of the sponsor server 119, and in the present example includes an alphanumeric identifier FG001A-98DDJ associated with financial server 119.

Field 2 of Table 6, “Program Name” contains the identifier of a given program associated with the sponsor server 119 in Field 1, and in the present example includes an alphanumeric identifier ‘Presidents_day_promotion_A’.

Field 3 of Table 6, “Inclusion List” contains the inclusion list for the program identified in Field 2, and in the present example includes the identifier associated with financial server 118-2, XYZ Bank Co.

Field 4 of Table 6, “Program” contains the rules governing the sponsorship program, and in the present example indicates that the sponsorship program will address 100% of service charges and fees to and from accounts in the inclusion list identified in Field 3, on Feb. 16, 2009.

Field 5 of Table 6, “Marketing Message” contains the nature of the marketing message associated with the program identified in Field 2, and in the present example indicates that a SMS message is to be sent to the associated device or subscriber.

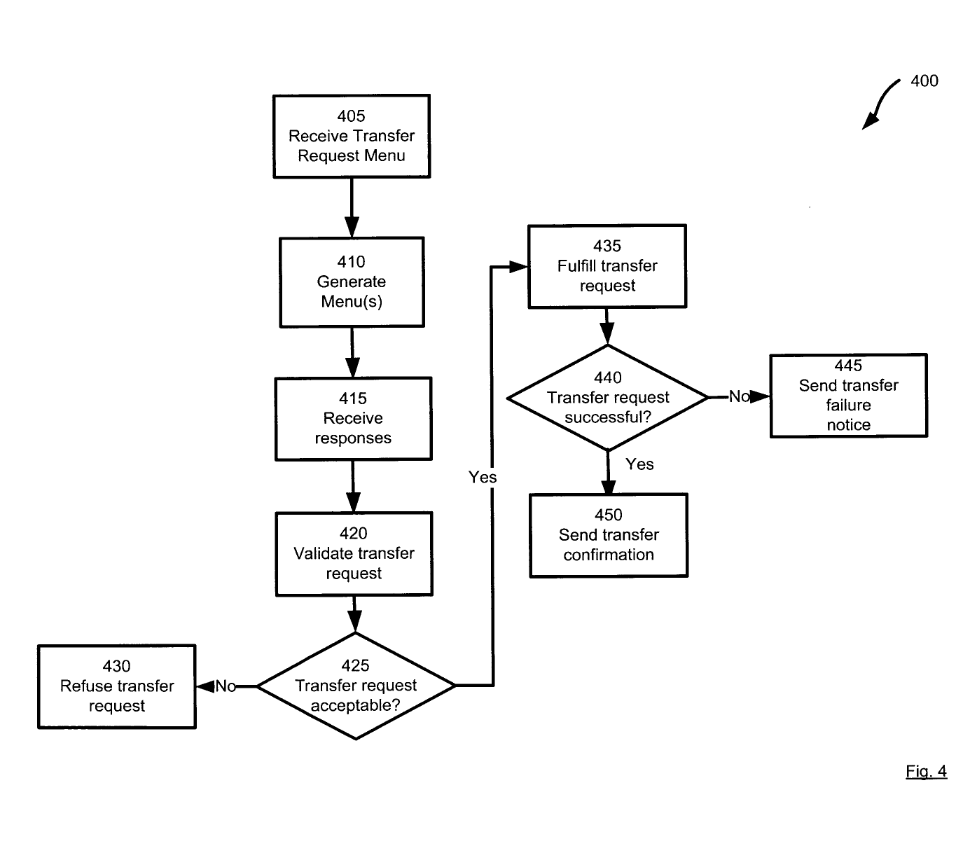

Referring now to FIG. 4, a method of conducting a transaction is provided in the form of a flowchart and indicated generally at 400. Method 400 can be implemented on system 50 and invoked via device 54, and is typically performed by universal transaction gateway 78. Method 400 can utilize profile database 86 that is generated by method 300 or other means. It should be understood that variations to at least one of method 400 and system 50 are contemplated.

Block 405 comprises receiving a transfer request menu. In system 50, and in the present non-limiting example, the transfer request menu is received in the form of the USSD code *9999# which is entered into device 54 and sent to core mobile network 62. Code *9999# is uniquely recognized by core mobile network 62 as being associated with universal transaction gateway 78. Interface 80 will thus receive the USSD code *9999# and identify its source as being device 54 via the MSISDN+1-234-567-8901 unique identifier associated with device 54.

At block 410 a menu is generated in response to the request at block 410. Continuing with the present, non-limiting example, engine 82 can be configured to implement block 410 by generating one (or more) USSD menus to be sent to and generated on display 208 of device 54 using the contents of Table I as stored in profile database 86. A series of menus can be generated that include for example the following:

Menu 1: “Select the Account from which you are transferring funds; 1. VISA Account 5555-5555-5555-5555; 2. XYZ Bank Co. Account Number 4444-4444-4444-4444”;

Menu 2: “Select the Account to which you are transferring funds; 1. VISA Account 5555-5555-5555-5555; 2. XYZ Bank Co. Account Number 4444-4444-4444-4444”;

Menu 3: “Enter the amount of funds, in US Dollars, that you are transferring”

Responses to each menu are provided at block 415. Upon responding to each menu item the “Send” or equivalent key on device 54 is depressed to send the responses back to engine 82.

At block 420, the request is validated. In the present example, block 420 is performed by engine 82 which checks the validity and formation of the request. For example, as part of block 420 engine 82 can verify that the “from” account and the “to” account are not identical. As another example, engine 82 can query the reporting and analysis engine 120 for the purpose of determining if a given transaction is associated with fraudulent activity. Other validation checks can include: whether the target account is on the exclusion list for a given device 54 or subscriber S, whether the amount transferred exceeds the limits associated with a given device 54 or subscriber S, whether the amounts transferred complies with regulatory requirements, and/or whether the class or category of the account associated with the “from” account is permitted to undertake the requested financial transaction with the “to” account. If available, other criteria for verifying or validating if the transfer request is well-formed can be derived from any such criteria as stored in profile database 86.

If the request is not well-formed or otherwise validated at block 420, then at block 425 a determination is made that the request is not acceptable and the request is refused at block 430, and typically a response would be sent indicating as such. In the present non-limiting example, the refusal notice would be sent to device 54 via USSD, SMS, or e-mail.

If the request is validated at block 420, then at block 425 a determination is made that the request is acceptable and then at block 435 the request is fulfilled, or at least an attempt to do so is effected. Assuming that the request from block 415 was a request to transfer $500 from XYZ Bank Co. Account Number 4444-4444-4444-4444 to VISA Account 5555-5555-5555-5555, then at block 435, via an interface 110 corresponding to server 118-2, engine 82 will access server 118-2 to debit XYZ Bank Co. Account Number 4444-4444-4444-4444 in the amount $500, and if that transaction is successful, then engine 82 will, via an interface 110 corresponding to server 118-1, access server 118-1 to credit VISA Account 5555-5555-5555-5555 in the amount $500 less any applicable service charges and tariffs. To the extent that the destination account is associated with a different currency relative to the source account, the amount credited to the destination account would be modified by the applicable currency exchange rate.

In an embodiment the service charges or tariffs can be deducted from the source or “from” account. With reference to the example, at block 435, the amount debited via financial server 118-2 will be $500 plus any applicable service charges and tariffs and the amount credited via financial server 118-1 will be $500.

In an embodiment the associated service charges or tariffs can be debited or credited to an account accessible via interface 110 or to an account stored by universal transaction gateway 78. For example, with reference to the example, at block 435, the associated service charges and tariffs can be credited to an account associated with a financial server 118 on commission database 91. If any of the foregoing fails at block 435, engine 82 will perform any appropriate roll-back and send a failure notice to device 54 at block 445. (If a rollback of, for example, the debiting of $500 from XYZ Bank Co. Account Number 4444-4444-4444-4444 is not successful, where such a rollback was attempted because a crediting of VISA Account 5555-5555-5555-5555 was not successful, then engine 82 can be configured to store a $500 “credit” in an association with an account specific to device 54 that is maintained in local account database 90. This scenario could occur, for example, if connectivity over network 114 were to fail upon completion of the debiting of server 118-2 but prior to the crediting of server 118-1.)

If, however, steps taken at 435 were successful, then a confirmation notice is sent to device 54 at block 450.

In an embodiment, at least one event record or log that describes the details of a successful or unsuccessful transactions processed via the universal transaction gateway will be generated by engine 82 and stored in event record database 87 for subsequent usage and/or inspection.

As another example, the provisioning of one or more accounts at method 300 can be dynamic, such that, for example, as part of performing block 415, a specific destination account to which funds can be transferred can be specified. The destination account for a transfer could be dynamically specified at block 415 to include an IMEI or MSISDN of another device so that funds are transferred to a prepaid or postpaid account associated with that other device. Alternatively, the destination account for a transfer could be dynamically specified at block 415 to include a VISA account number so that funds are transferred to that specified VISA account.

As another example, the successful requests can be associated with a loyalty or promotion program. As a result of block 435, the state or counter of the applicable loyalty or promotion program can be updated accordingly. For example, a given loyalty promotion ‘Air_time_promotion_a’ can be configured to credit the equivalent of $2 in the default currency associated with device 54 or subscriber S in a designated pre-paid account hosted by financial server 118-4 (subject to currency exchange rates if the currency associated with the designated pre-paid account is different than the currency associated with the loyalty promotion) for every 10 financial transfers undertaken by device 54 or subscriber s over a given chronological period (e.g. a month).

This example can be applicable or desired to transfer prepaid funds from a prepaid account stored on an SCP server 118 associated with device 54 to another prepaid funds account stored on an SCP server 118 that is associated with another device like device 54. In another embodiment, the example can be applicable or desired to transfer prepaid funds from a prepaid account stored on an SCP server 118 associated with device 54 to another prepaid funds account to a distinct SCP server 118 associated with another device like device 54 maintained by another network operator. It will be apparent that the associated devices, subscribers, and financial servers may be located in different countries or jurisdictions. A vast variety of other use-cases will now occur to those skilled in the art.

In an embodiment the universal transaction gateway 78 can be used to effect the distribution of monetary or non-monetary unit credits via transfers between intermediary accounts accessible via interface 110 or stored on the universal transaction gateway 78 via local database 90 or commission database 91. For example, a reseller subscriber can effect transfers to retail subscribers by invoking transfers from a given source account maintained in local database 90 to a given account associated with a retail subscriber either maintained in local database 90 or accessible via interface 110. Associated service charges or tariff charges can be credited to or debited from either the source or destination account. Associated service charges or tariff charges can also be credited to or debited from an account maintained by commission database 91. A vast variety of other use-cases will now occur to those skilled in the art.

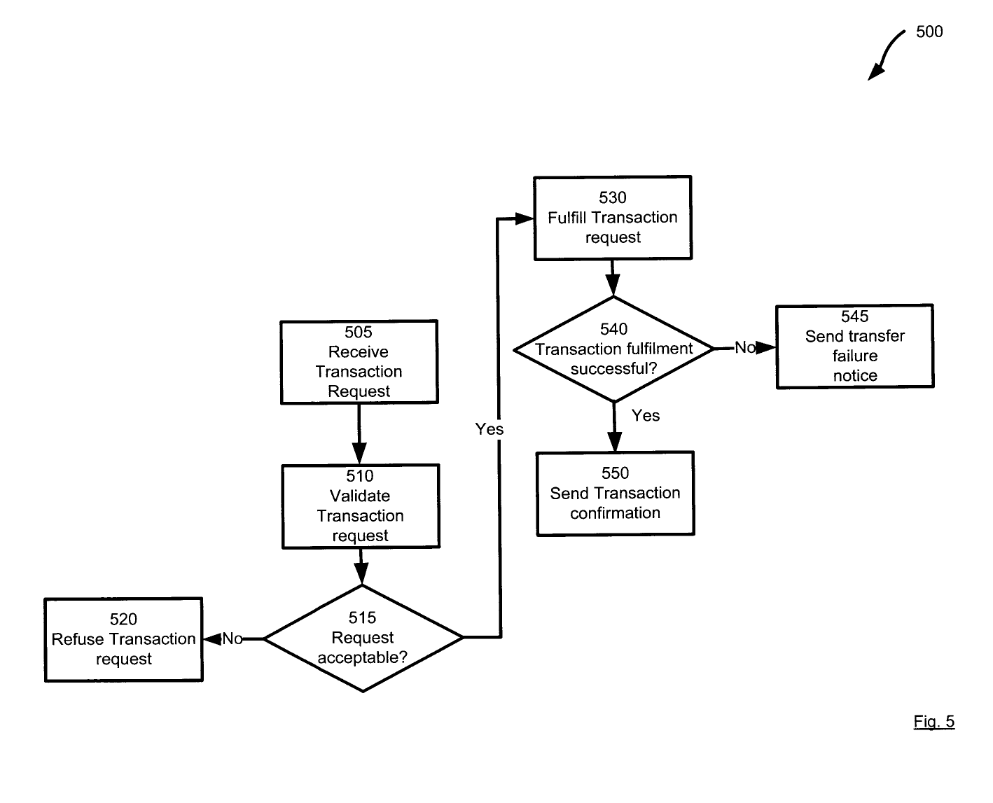

Referring now to FIG. 5, a method of conducting a transaction invoked via a financial server 118 is provided in the form of a flowchart and indicated generally at 500. For example, a financial server may periodically top-up a given air-time account associated with a device 54 or subscriber S. Method 500 can be implemented on system 50, and is typically performed by universal transaction gateway 78. Method 500 can utilize profile database 86 that is generated by method 300 or other means. It should be understood that variations to at least one of method 500 and system 50 are contemplated.

Block 505 comprises receiving a request from a financial server 118 that contains parametric information that indicates the destination account via a unique identifier, the amount to be transferred, and the currency associated with the amount to the transferred.

At block 510, the request is validated. In the present example, block 510 is performed by engine 82 which checks the validity and formation of the request. For example, as part of block 520 engine 82 can verify that the “from” account and the “to” account are not identical. As another example, engine 82 can query the reporting and analysis engine 120 for the purpose of determining if a given transaction is associated with fraudulent activity. Other validation checks can include: whether the target account is on the exclusion list for a given financial server 118, whether the amount transferred exceeds the limits associated with a given device 54 or subscriber S, and whether the amounts transferred complies with regulatory requirements. If available, other criterion for verifying or validating if the transfer request is well-formed can be derived from any such criteria as stored in profile database 86.

If the request is not well-formed or otherwise validated at block 510, then at block 515 a determination is made that the request is not acceptable and the request is refused at block 520, and typically a response would be sent indicating as such. In the present non-limiting example, the refusal notice would be sent to device 54 via USSD, SMS, or e-mail and/or the financial server via an applicable interface and protocol.

If the request is validated at block 510, then at block 515 a determination is made that the request is acceptable and then at block 530 the request is fulfilled, or at least an attempt to do so is effected. Assuming that the request from block 505 was a request to transfer $10 from XYZ Bank Co. Account Number 4444-4444-4444-4444 to AirMax Operator Pre-Paid Account+1-234-567-8901, then at block 530, via an interface 110 corresponding to server 118-2, engine 82 will access server 118-2 to debit XYZ Bank Co. Account Number 4444-4444-4444-4444 in the amount $10, and if that transaction is successful, then engine 82 will, via an interface 110 corresponding to server 118-4, access server 118-4 to credit AirMax Operator Pre-Paid Account+1-234-567-8901 in the amount $10 less any applicable service charges and tariffs. To the extent that the destination account is associated with a different currency relative to the source account, the amount credited to the destination account would be modified by the applicable currency exchange rate.

In an embodiment the service charges or tariffs can be credited or debited from an account maintained by commission database 91. With reference to the example, at block 530, the applicable service charges and tariffs can be credited to an account associated with financial server 118-2 maintained by commission database 91.

As another example, the successful requests can be associated with a loyalty or promotion program. As a result of block 530, the state or counter of the applicable loyalty or promotion program can be updated accordingly. For example, a given loyalty promotion ‘Air_time_promotion_a’ can be configured to credit the equivalent of $2 in the default currency associated with device 54 or subscriber S in a designated pre-paid account hosted by financial server 118-4 (subject to currency exchange rates if the currency associated with the designated pre-paid account is different than the currency associated with the loyalty promotion) for every 10 financial transfers associated with device 54 or subscriber s over a given chronological period (e.g. a month).

If any of the foregoing fails at block 530, engine 82 will perform any appropriate roll-back and send a failure notice to device 54 or subscriber S or financial server 118 at block 545. (If a rollback of, for example, the debiting of $10 from XYZ Bank Co. Account Number 4444-4444-4444-4444 is not successful, where such a rollback was attempted because a crediting of AirMax Operator Pre-Paid Account+1-234-567-8901 was not successful, then engine 82 can be configured to store a $10 “credit” in an association with an account specific to device 54 or subscriber S that is maintained in local account database 90. This scenario could occur, for example, if connectivity over network 114 were to fail upon completion of the debiting of server 118-2 but prior to the crediting of server 118-4.) If, however, steps taken at 530 were successful, then a confirmation message is sent to financial server 118-2 at block 550 and/or device 54 or subscriber S.

In an embodiment, at least one event record or log that describes the details of a successful or unsuccessful transactions processed via the universal transaction gateway will be generated by engine 82 and stored in event record database 87 for subsequent usage and/or inspection.

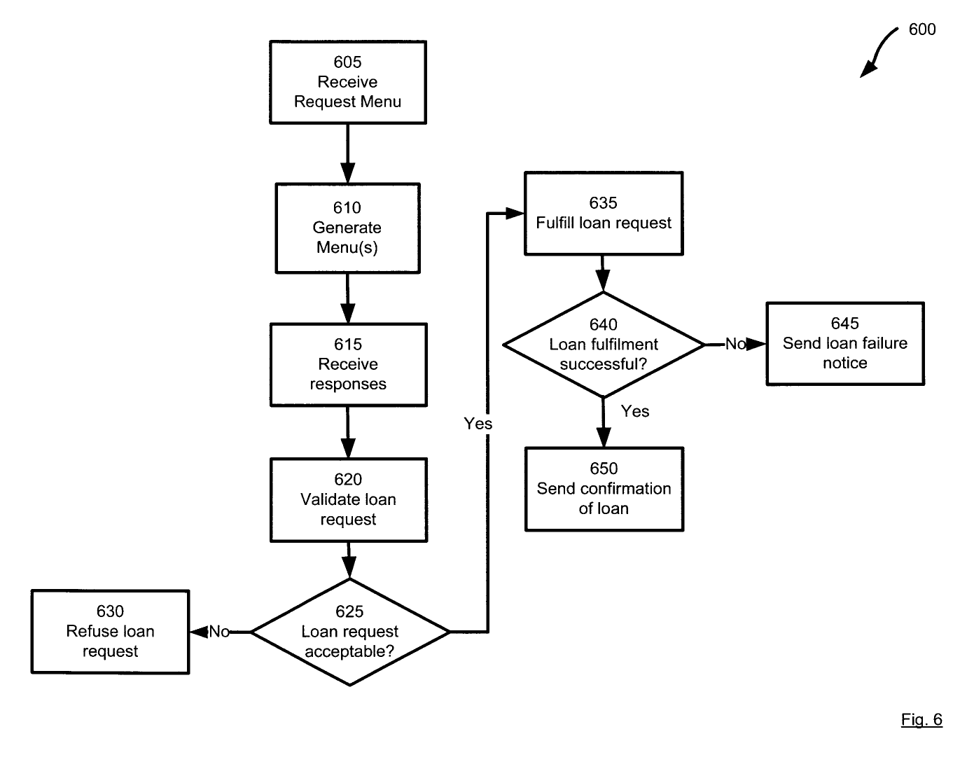

Referring now to FIG. 6, a method of conducting a loan transaction invoked via device 54 is provided in the form of a flowchart and indicated generally at 600. Method 600 can be implemented on system 50, and is typically performed by universal transaction gateway 78. Method 600 can utilize profile database 86 that is generated by method 300 or other means. It should be understood that variations to at least one of method 600 and system 50 are contemplated.

Block 605 comprises receiving a request menu. In system 50, and in the present non-limiting example, the request menu is received in the form of the USSD code *9999# which is entered into device 54 and sent to core mobile network 62. Code *9999# is uniquely recognized by core mobile network 62 as being associated with universal transaction gateway 78. Interface 80 will thus receive the USSD code *9999# and identify its source as being device 54 via the MSISDN+1-234-567-8901 unique identifier associated with device 54.

At block 610 a menu is generated in response to the request at block 610. Continuing with the present, non-limiting example, engine 82 can be configured to implement block 610 by generating one (or more) USSD menus to be sent to and generated on display 208 of device 54 using the contents of Table I as stored in profile database 86. A series of menus can be generated that include for example the following:

Menu 1: Select the financial transaction: 1. Loan/Borrow Funds. 2. Account Balance.

Menu 2: “Select the Account from which you are borrowing funds; 1. VISA Account 5555-5555-5555-5555; 2. XYZ Bank Co. Account Number 4444-4444-4444-4444”;

Menu 3: “Enter the amount of funds, in US Dollars, that you would like to borrow”

Responses to each menu are provided at block 615. Upon responding to each menu item the “Send” or equivalent key on device 54 is depressed to send the responses back to engine 82.

At block 620, the request is validated. In the present example, block 620 is performed by engine 82 which checks the validity and formation of the request. For example, as part of block 620, where Menu 2 is being invoked, engine 82 can verify that the “from” account and the “to” account are not identical. As another example, engine 82 can query the reporting and analysis engine 120 for the purpose of determining if a given transaction request is associated with fraudulent activity. Other validation checks can include: whether the target account is on the exclusion list for a given device 54 or subscriber S, whether the amount transferred exceeds the limits associated with a given device 54 or subscriber S, and whether the amounts transferred complies with regulatory requirements. As another example, engine 82 can verify whether the amount of funds being requested to be borrowed using Menu 3 is a positive or negative amount. If a negative amount, the request would not be validated. If available, other criterion for verifying or validating if the transfer request is well-formed can be derived from any such criteria as stored in profile database 86.

If the request is not well-formed or otherwise validated at block 620, then at block 625 a determination is made that the request is not acceptable and the request is refused at block 630, and typically a response would be sent indicating as such. In the present non-limiting example, the refusal notice would be sent to device 54 via USSD, SMS, or e-mail.

If the request is validated at block 620, then at block 625 a determination is made that the request is acceptable and then at block 635 the request is fulfilled, or at least an attempt to do so is effected. Assuming that the request from block 615 was a request to borrow $100 from XYZ Bank Co. Account Number 4444-4444-4444-4444 and to credit that amount to an account (e.g. an account specific to device 54 or subscriber S) that is maintained in local account database 90, then at block 635, via an interface 110 corresponding to server 118-2, engine 82 will access server 118-2 to debit XYZ Bank Co. Account Number 4444-4444-4444-4444 in the amount $100, and if that transaction is successful, then engine 82 will credit an account specific to device 54 that is maintained in local account database 90 in the amount $100 less any applicable service charges and tariffs. To the extent that the destination account is associated with a different currency relative to the source account, the amount credited to the destination account would be modified by the applicable currency exchange rate.

In an embodiment the service charges or tariffs can be deducted from the source or “from” account. With reference to the example, at block 635, the amount debited via financial server 118-2 will be $100 plus any applicable service charges and tariffs and the amount credited to the account maintained by local database 90 will be $100. If any of the foregoing fails at block 635, engine 82 will perform any appropriate roll-back and send a failure notice to device 54, subscriber S, or financial server 118 at block 645.

If, however, steps taken at 635 were successful, then a confirmation notice is sent to device 54 at block 650. The device 54 or subscriber S may in turn elect to invoke other financial transfers to transfer the funds to or from the account specific to device 54 or subscriber S that is maintained in local account database 90 per the capabilities accorded by the universal transaction server 78.

It should now be apparent that method 600 can be modified to utilize loan credit account database 92.

In an embodiment, at least one event record or log that describes the details of a successful or unsuccessful transactions processed via the universal transaction gateway will be generated by engine 82 and stored in event record database 87 for subsequent usage and/or inspection.

In an embodiment, a given request invoked by a device 54 or subscriber S can be effected using an account maintained by universal transaction gateway 78 via local database 90 or commission database 91. The resulting transfer can result in either a debit or credit of either a monetary currency or non-monetary unit. For example, a device 54 or subscriber S can request that an amount be transferred to an account maintained by financial server 118 by debiting an account maintained by local database 90. As another example, a device 54 or subscriber S can request that an amount be transferred to a given destination account (‘account a’) associated with device 54 or subscriber S (as identified via a unique identifier) maintained by local database 90 by debiting another source account (‘account b’) associated with device 54 or subscriber S (as identified via a unique identifier) maintained by local database 90. In turn, device 54 or subscriber S can effect additional financial transactions using the credit amount in ‘account a’ (e.g. transferring amounts to accounts associated with other devices or subscribers or transferring amounts to accounts accessible via interface 110). A vast variety of other “use cases” will now occur to those skilled in the art.

To the extent that debit or credit amounts are maintained in the local account database 90 or commission database 91, the engine 82 can periodically accrue applicable interest charges per the interest data provisioned in profiler server 86.

While the foregoing discusses certain embodiments, it is to be understood that such embodiments are by way of example only, and that variations, combinations, and subsets thereof are contemplated. For example, while the specific example above referred to a USSD interface being implemented at interface 80, other types of interfaces can be implemented, as previously discussed. As another example, it should be understood that any number of financial server 118 accounts can be associated with device 54. Such financial server 118 accounts need not actually belong to subscriber S of device 54. For example, a financial server 118 account can be associated with a relative of the user of device 54, and database 86 can be configured to only allow “crediting” of that other financial server 118, and to disallow debiting. In this manner, funds can be “wired” to relatives via a traditional wireless telephone interface. As a related example, where the financial server 118 is a Western Union server, then the transfer of funds could result in cash being available to be picked up in the usual manner from a Western Union outlet. As another example, not all of the elements within gateway 78 need be provided in a given installation.

In a given embodiment, a given financial transaction can be subject to service charges and tariffs. Service fees can be positive or negative and can either be added to the amount to be deducted from the contributor account, affect the value that is transferred or exchanged before being deposited into the destination account, or be credited to or debited from another account such as an account maintained by the commission database 91. A service charge fee can be defined as a percentage of the value of the transaction or as a flat fee, or tiered as a function of the transaction value. Other possible variations on service fees are possible. The application of negative or positive service charge fees as well as the ability to apply charges to contributor, destination, or other accounts supports a variety of use cases. One example would consist of a scenario whereby a reseller subscriber would receive $100 of a given currency or one-hundred credits of a given non-monetary unit in an account stored in database 90 on the universal transaction gateway 78. The reseller subscriber can in turn transfer $100 of a given currency or one-hundred credits of a given non-monetary unit to a retail subscriber account as stored in financial server 118-4 and be deducted only $90 of a given currency or 90 credits of a given non-monetary whereby the application of a negative $10 or ten credit surcharge amounts to an effective commission to the reseller subscriber. Another example is a scenario whereby a given financial transaction initiated by a device 54 or subscriber S with a financial server 118 would result in the applicable service charges or tariff fees to be credited to an account associated with financial server 118 maintained by commission database 91. As a variant to the preceding example, the applicable service charges or tariff fees can be apportioned among more than one account. For example, the applicable service charges or tariff fees can be credited to an account associated with financial server 118 maintained by commission database 91 as well as another designated account associated with the operator of universal transaction gateway 78 maintained by commission database 91 per criteria maintained in profile database 86. A vast variety of other use-cases will now occur to those skilled in the art.

In an embodiment the associated service charges or tariffs associated with a given financial transaction can be sponsored or subsidized in their entirety or in part either in connection with a loyalty or promotional program or in connection with a marketing program associated with at least one sponsor associated with sponsor server 119 per the sponsorship program attributes maintained by sponsorship database 88.

In an embodiment the universal transaction gateway 78 can notify the device 54 or subscriber S based on accounts reaching threshold values or on a periodic basis based on data maintained in profile database 86. For example, a SMS can be generated by engine 82 and sent to a given device 54 or subscriber S via interface 80 that a given account balance has dropped below a given threshold value.

1. A universal financial transaction gateway comprising:
at least one network interface for connecting to a computing device via a network; said at least one interface configured to emulate an interface inherent to said network;
a transaction engine connected to said interface configured to receive transaction instructions from said mobile computing device via said network interface;
a plurality of financial server interfaces for connecting to a plurality of accounts associated with a plurality of financial servers; said plurality of financial server interfaces configured to emulate an interface inherent to each of said financial servers; and,
said transaction engine configured to effect said transaction instructions on said financial servers via said financial server interfaces.

2. The universal financial transaction gateway of claim 1 wherein said network interface is a core mobile network interface and said network is a core mobile network and said mobile computing device is a mobile electronic device.

3. The universal financial transaction gateway of claim 2 wherein said core mobile network interface is at least one of an Unstructured Supplementary Service Data (USSD) gateway interface; a short message service (SMS) center (SMSC) interface; an interactive voice response (IVR) system interface; an Internet Protocol (IP) interface.

4. The universal financial gateway of claim 3 wherein the Internet Protocol interface includes a Wireless Application Protocol (WAP) interface; a Session Initiation Protocol interface, a Hypertext Transfer Protocol interface, and Extensible Markup Language interface

5. The universal financial transaction gateway of any one of claims 1-4 wherein said accounts associated with said financial servers comprise one or more of a credit card account, a credit line account, a bank account, a cash wire transfer account, a prepaid wireless account, Operational Support System (OSS)/Business Support System (BSS) account, a securities trading account, and a commodities trading account.

6. The universal financial transaction gateway of any one of claims 1-5 further comprising a local account database configured to maintain at least one account associated with said mobile computing device or with a subscriber associated with said mobile computing device.

7. The universal financial transaction gateway of any one of claims 5-6 wherein at least one of said financial servers maintain at least one account associated with said mobile computing device or said subscriber.

8. The universal financial transaction gateway of any one of claims 1-7 wherein at least one of said financial servers maintain at least one account associated with another mobile computing device other than said mobile computing device, or with another subscriber associated with said other mobile computing device.

9. The universal financial transaction gateway of any one of claims 1-8 wherein said transaction instructions include at least one of a fund transfer between accounts; a loan request; an account balance request; a cash wire transfer; a credit or debit of a credit card account; a credit or debit of a bank account; a securities purchase or sale, a stock trade; a commodities purchase or sale, a futures purchase or sale, a bond purchase or sale.

10. The universal financial transaction gateway of any one of claims 1-9 wherein said transaction instructions include a first account on a first financial server associated with said mobile computing device or a first subscriber associated with said mobile computing device, and a second a account on a second financial server not associated with said mobile computing device or a second subscriber not associated with said mobile computing device.

11. A method of conducting a universal financial transaction comprising:
receiving transaction instructions via a network interface connected to mobile computing device via a network; said network interface configured to emulate an interface inherent to said network;
processing said transaction instructions;
sending said transaction instructions via at least one financial server interface; said financial server interface for connecting to a plurality of accounts associated with at least one financial server; said financial server interface configured to emulate an interface inherent to said financial server.

12. The method of claim 11 further comprising validating said transfer request and only proceeding to said processing if said transfer request is successfully validated.

13. The method of claim 11 further wherein said processing includes effecting an account debit or credit at a local account database.

14. The method of claim 11 wherein said network interface is a core mobile network interface and said network is a core mobile network and said mobile computing device is a mobile electronic device.

15. The method of claim 14 wherein said core mobile network interface is at least one of an Unstructured Supplementary Service Data (USSD) gateway interface; a short message service (SMS) center (SMSC) interface; an interactive voice response (IVR) system interface; an Internet Protocol (IP) interface.

16. The universal financial gateway of claim 15 wherein the Internet Protocol interface includes a Wireless Application Protocol (WAP) interface; a Session Initiation Protocol interface, a Hypertext Transfer Protocol interface, and Extensible Markup Language interface

17. The method of any one of claims 11-16 wherein said accounts associated with said financial servers comprise one or more of a credit card account, a credit line account, a bank account, a cash wire transfer account, a prepaid wireless account, Operational Support System (OSS)/Business Support System (BSS) account, a securities trading account, and a commodities trading account.

18. The method of any one of claims 11-17 further comprising a local account database configured to maintain at least one account associated with said mobile computing device or with a subscriber associated with said mobile computing device.

19. The method of any one of claims 17-18 wherein at least one of said financial servers maintain at least one account associated with said mobile computing device or said subscriber.

20. The method of any one of claims 11-19 wherein at least one of said financial servers maintain at least one associated with another mobile computing device other than said mobile computing device, or with another subscriber associated with said other mobile computing device.

21. The method of any one of claims 11-20 wherein said transaction instructions include at least one of a fund transfer between accounts; a loan request; an account balance request; a cash wire transfer; a credit or debit of a credit card account; a credit or debit of a bank account; a securities purchase or sale, a stock trade; a commodities purchase or sale, a futures purchase or sale, a bond purchase or sale.

22. The method of any one of claims 11-21 wherein said transaction instructions include a first account on a first financial server associated with said mobile computing device or a first subscriber associated with said mobile computing device, and a second a account on a second financial server not associated with said mobile computing device or a second subscriber not associated with said mobile computing device.

23. A transaction engine in accordance with the transaction engine of claim 1.
